(19) United States
(12) Patent Application Publication
(10) Pub. No.: US 2013/0318967 A1
(43) Pub. Date: Dec. 5, 2013

(54) WASTE HEAT RECOVERY DEVICE

(71) Applicant: DAIMLER AG, Stuttgart (DE)

(72) Inventors: Jan Gaertner, Leonberg (DE); Thomas Koch, Boeblingen (DE)

(73) Assignee: DAIMLER AG, Stuttgart (DE)

(21) Appl. No.: 13/902,785

(22) Filed: May 25, 2013

Related U.S. Application Data
(63) Continuation-in-part of application No. PCT/EP2011/005425, filed on Oct. 27, 2011.

(30) Foreign Application Priority Data
Nov. 26, 2010 (DE) 10 2010 052 508.1

(51) Int. Cl. F02G 1/044; F01B 3/10; F02B 67/00; F01N 5/02; F02G 1/045

(52) U.S. Cl. CPC F02G 1/044; F01N 5/02; F02G 1/045; F02B 67/00; F01B 3/102
USPC 60/615; 60/618; 91/505; 60/620

(57) ABSTRACT

In an axial piston expander for a waste heat recovery device of a motor vehicle, the expander having a shaft with an axis of rotation around which a number of cylinders are arranged parallel to, and distributed around, the axis of rotation, each cylinder including a piston connected to a coupling plate which is pivotally mounted on the shaft so as to provide for an adjustable piston stroke and the cylinders having high pressure inlets and low pressure outlets with valve devices for the control of the operating fluid flow through the cylinders, a stroke adjustment arrangement is provided by which the stroke of the pistons is adjustable via a regulation of the pressure in an operating chamber at the back side of the pistons, the waste heat recovery device being coupleable with the drive train of the internal combustion engine for the transfer of mechanical driving power.

This is a Continuation-In-Part application of pending international patent application PCT/EP2011/005425 filed Oct. 27, 2011 and claiming the priority of German patent application 10 2010 052 508.1 filed Nov. 26, 2010.

### BACKGROUND OF THE INVENTION

The present invention relates to a waste heat recovery device and an axial piston expander for such a waste heat recovery device.

A conventional waste heat recovery device is known, for example, from EP 1 533 494 A2. It comprises a waste heat recovery circuit, in which a working medium circulates. A delivery device to drive the fluid working medium is arranged in the waste heat recovery circuit. An evaporator for the evaporation of the working medium is positioned in the waste heat recovery circuit downstream of this delivery device. In addition, an expansion machine is provided in the waste heat recovery circuit downstream of the evaporator for the relief of the working medium. Downstream of this expansion machine there is a condenser for the condensation of the working medium. In the known waste heat recovery device the expansion machine drives a generator for the generation of electrical energy. The evaporator is heated by means of a burner, which is provided in a motor vehicle in addition to an internal combustion engine.

Such a heat recovery device usually operates in accordance with the principle of the Rankine cycle.

An air conditioning system is known from DE 10 2007 051 127 A1, which has an axial piston compressor to drive the gaseous coolant in a coolant circuit. The axial piston compressor has a variable displacement volume, so that the delivery performance, in particular the delivery volume and/or delivery pressure can be set independently of a rotational speed of a drive shaft of the axial piston compressor.

Axial piston compressors with adjustable stroke are known, for example, from DE 101 24 033 B4, DE 101 24 034 A1, DE 101 24 031 B4, EP 0 964 997 B1 and DE 103 43 570 A1. Usually such an axial piston compressor comprises a drive shaft, which is mounted in bearings to rotate about an axis of rotation and into which mechanical drive power can be introduced to drive the axial compressor. In addition a number of cylinders are provided which are orientated parallel with and distributed circumferentially around the axis of rotation of the drive shaft. In each of these cylinders a piston with an adjustable stroke is arranged parallel to the axis of rotation. In addition a coupling plate is provided, which is in driven connection with all pistons and with the drive shaft and whose inclination relative to the axis of rotation determines the stroke of the pistons. A low pressure inlet is in fluidic connection with the cylinders. A high pressure outlet is likewise in fluidic connection with the cylinders. Furthermore a valve device can be provided for the control of the fluidic connections between the cylinders and the low pressure inlet and also the high pressure outlet. In order to be able to adjust the output of the axial piston compressor independently of the speed of the drive shaft, a stroke adjustment device can be provided, by means of which the stroke of the pistons can be adjusted. For example, the inclination of the coupling plate relative to the axis of rotation can be adjusted for this purpose, whereby a variation of the stroke of the pistons takes place.

With the assistance of a waste heat recovery device on an internal combustion engine, which in particular can be arranged in a motor vehicle, heat can be used in order to improve the energy efficiency of the internal combustion engine and of the vehicle. To this end heat is converted into mechanical driving power using the expansion machine of the waste heat recovery device, which is then converted into a further form of energy, other than that of heat, for example into electrical energy. The electrical energy won by this means can be used in various ways, so that the overall efficiency of the internal combustion engine and of the thus equipped vehicle is improved.

It is frequently desired in the context of vehicle applications that the driving power of the internal combustion engine be supported by means of a waste heat recovery device. With the assistance of the waste heat recovery device first electrical energy can be won and this then converted into mechanical driving power via at least one electric motor, in order to support the internal combustion engine. However, only a comparatively small benefit is obtained, since the mechanical energy rendered available with the aid of the expansion machine is subject to losses as it is first converted into electrical energy and then subject to further losses as it is converted back again into mechanical work. A direct usage of the mechanical power provided by the expansion machine for the support of the internal combustion engine is problematic in vehicle applications, since in the case of vehicles the internal combustion engine is frequently associated with operating conditions with varying load and/or speed. A support of the driving power of the internal combustion engine by the waste heat recovery device is therefore associated with the fact that the speed of the expansion machine also varies accordingly. A speed variation of the expansion machine leads to changes in the waste heat recovery device, which typically is in the form of a Rankine cycle process. For example, the throughput of the expansion machine can change the heat absorption in the evaporator, the value of the high pressure and/or of the low pressure, the pressure difference at the expander and much more. Operating conditions within the waste heat recovery device that lie outside suitable, specified parameters must also be considered by the waste heat recovery device.

The object of the invention is to provide an axial piston expander and a waste heat recovery device, which facilitate an improved mechanical support of the internal combustion engine by the waste heat recovery device. A further objective is to there by improve the efficiency of an internal combustion engine.

### SUMMARY OF THE INVENTION

In an axial piston expander for a waste heat recovery device of a motor vehicle, the expander having a shaft with an axis of rotation around which a number of cylinders are arranged parallel to, and distributed around, the axis of rotation, each cylinder including a piston connected to a coupling plate which is pivotally mounted on the shaft so as to provide for an adjustable piston stroke and the cylinders having high pressure inlets and low pressure outlets with valve devices for the control of the operating fluid flow through the cylinders, a stroke adjustment arrangement is provided by which the stroke of the pistons is adjustable via a regulation of the pressure in an operating chamber at the back side of the pistons, the waste heat recovery device being coupleable with the drive train of the internal combustion engine for the transfer of mechanical driving power.

The stroke control for the pistons can, for example, be achieved in that on the high pressure side of the waste heat recovery circuit upstream of the high pressure inlet of the axial piston expander a partial flow of the working medium, which preferably is less than 10% of the overall flow, is conducted via a first throttle into an operating chamber of the axial piston expander and then fed back via a second throttle on the low pressure side of the waste heat recovery circuit downstream of the low pressure outlet. One of the two throttles is provided as a controllable element, e.g. as a timing valve, whereby it is possible to adjust the pressure in the operating chamber. Via such an operating chamber pressure control the stroke of the pistons can be adjusted. The stroke control thus takes place via an operating chamber pressure regulation. The operating chamber pressure regulation thus takes place by regulation of the high pressure/low pressure in the bypass, whereby the bypass of the flow path guided through the operating chamber is for the partial flow. It is useful if the bypass has a constant throttle and an adjustable throttle, such as, for example, a timing valve. By this means the operating chamber pressure can be set to a pressure value, which lies between the high pressure and the low pressure of the waste heat recovery circuit.

In this way it is possible to directly mechanically couple the expansion machine with a drive train of the internal combustion engine. Varying operating conditions of the internal combustion engine, which lead to different rotational speeds in the drive train, do not present a problem for the expansion machine, since the speed of the driven shaft of the axial piston expander is forcibly controlled via the drive shaft for the internal combustion engine. On a change in the speed of the driven shaft the piston stroke times change. A change in the speed of the driven shaft changes also the mass flow at the expander and hence the thermal absorption in the evaporator. This can lead to a reduction in the efficiency of the waste heat recovery device. Due to the change in the piston stroke according to the invention the waste heat recovery circuit can be sufficiently quickly adjusted. The mass flow can be readjusted by this means, e.g. with the aim of keeping the pressure conditions the same or of regulating the waste heat recovery arrangement to a favorable operating point.

By this means the losses are avoided, which can occur due to the multiple conversion of the form of energy from thermal energy via kinetic energy to electrical energy and if required, back to kinetic energy and due to possible operation of the waste heat recovery circuit outside of optimized basic conditions.

The term “Piston stroke” refers to the extent of the stroke of the piston between its reversal points, i.e. between one assigned to the minimum cylinder volume at the top dead center and one assigned to the maximum cylinder volume at bottom or lower) dead center. This represents a stroke control, whose limits are determined by the current pressure ratio in the waste heat recovery device.

According to an embodiment the axial piston expander is characterized in that the operating chamber can be connected with a high pressure bypass of the high pressure outlet for the adjustment of the operating chamber pressure.

By this means the operating chamber pressure can assume a maximum value, which corresponds to the high pressure built up in the piston chamber.

According to an exemplary embodiment the operating chamber of the axial piston expander can be connected to a low pressure bypass of the low pressure outlet for the adjustment of the operating chamber pressure. By this means the operating chamber pressure can assume a minimum value, which corresponds to the low pressure, with which the expanded working medium emerges from the piston chamber. Furthermore the branched off working medium is fed via the low pressure bypass back into the circuit of the waste heat recovery device and is thus not lost as a working medium.

According to an embodiment at least one bypass has a pressure adjustment device. By this pressure adjustment device the operating chamber pressure and the pressure fed to the operating chamber can be adjusted. The operating chamber pressure is exerted on the operating chamber as well as on the pistons. Opposing this, the pressure arising in the piston chamber is also acting on the pistons. A differential pressure exists, by means of which the piston is pushed or pulled along with its piston rod on the inclination adjustment device of the axial piston expander.

According to an embodiment the pressure adjustment device is formed as a timing valve, as a constant throttle, or other throttle. These control devices are especially suited to finely regulate a pressure feed or pressure reduction, so that the desired pressure in the operating chamber is set quickly and sufficiently accurately.

According to a particular embodiment the pressure adjustment device is in the form of a timing valve arranged in one bypass and a throttle in the other bypass. By this means, for example, via a throttle arranged in the low pressure bypass, the desired upper pressure threshold can be set, above that at which the pressure in the low pressure bypass is to be relieved. The timing valve arranged in the high pressure bypass then feeds pulses of high pressure working medium until the throttle in the low pressure bypass discharges. Then the operating chamber pressure is set to the value prescribed with the throttle.

Particularly advantageously a stroke adjustment device of this type can be, or comprise, an inclination adjustment device, by which the inclination of the coupling plate can be adjusted relative to the axis of rotation. Since the inclination of the coupling plate relative to the axis of rotation determines the piston stroke via the mechanical coupling between the coupling plate and the piston, the piston stroke can be simply adjusted by changing the inclination between the coupling plate and the axis of rotation.

In another embodiment a valve device, which is provided for the control of the fluidic connections between the cylinders and the high pressure inlet and also the low pressure outlet can have an inlet valve in each cylinder for the control of the fluidic connection between the respective cylinder and the high pressure inlet, which is actuated to open by the related piston in the region of the top dead center (minimum cylinder volume), in other words, the respective piston actuates the related inlet valve itself, and in fact always in the region of its upper top dead center, i.e. at minimum cylinder volume. By this means it is achieved, that the inlet valve is always opened at the same, optimized piston position, which leads to increased functional security.

Particularly advantageously it can be provided, that the respective piston has an actuating element, which actuates the respective inlet valve to open in the region of the top dead center. In particular the respective actuating element can take the form of an axially-mounted element protruding from the piston, for example in the form of a finger or nose, whereby the protruding element moves to an open position to open the respective inlet valve. Through these features a mechanical actuation of the respective inlet valve is achieved, which is characterized by a particularly high degree of reliability.

In particular the respective inlet valve can take the form of a flutter valve, which is characterized in that as an adjustable valve element it has a pivoting flap moving about a pivot axis. In particular this pivot axis extends at right angles to the direction of stroke of the piston, which simplifies an actuation of the flap for opening by mechanical contacting, in particular by means of the actuating element.

According to a particularly advantageous embodiment the valve device can have a disk earn for the control of the fluidic connection between the cylinders and the low pressure outlet, rotating about the axis of rotation, which has at least one control slot axially extending through the disk cam. The fluidic connection between the low pressure outlet and the respective cylinder is then opened when the control slot is in axial alignment with the respective cylinder. On the other hand, in the remaining range of rotation of the disk cam the fluidic connection between the low pressure outlet and the respective cylinder is closed. Likewise, using a disk cam of this type a reliable control for the outlet side of the cylinder can be achieved. In particular, through the geometry, such as for example, width in the radial direction and/or length in the circumferential direction, of the control slot, a control characteristic for the outlet side of the cylinder can be obtained, which for example determines the point in time for the opening of the outlet nd the closing of the outlet, as well as the length of the outlet time window.

Particularly advantageously the control slot can extend in a circular arc relative to the axis of rotation. Additionally or alternatively the disk cam can be fixed so as to rotate with the drive shaft, whereby a simple and functionally-secure method of construction is achieved. Additionally or alternatively the respective cylinder can have an outlet opening, which is directly controlled by the disk cam. This lends itself to an inexpensive and compact design.

The invention likewise relates to a waste heat recovery device of a vehicle, with a waste heat recovery circuit, in which a working medium circulates, with a delivery device arranged in the waste heat recovery circuit to drive the fluid working medium, with an evaporator in the waste heat recovery circuit downstream of the delivery device for the evaporation of the working medium using waste heat from the internal combustion engine, with an expansion machine arranged in the waste heat recovery device downstream of the evaporator for the relief of the working medium, with a condenser arranged in the waste heat recovery circuit downstream of the expansion machine for the condensation of the working medium, whereby the expansion machine is coupled, or can be coupled with a drive train of the internal combustion engine for the transfer of mechanical drive power.

According to the invention the expansion machine is an axial piston expander whose stroke is regulated by means of an operating chamber pressure in accordance with one of the described embodiments, whose driven shaft is coupled, or can be coupled with the drive train of the internal combustion engine for the transfer of mechanical drive power.

In a waste heat recovery device, which is equipped with an axial piston expander of the type represented here, and with an internal combustion engine, which is equipped with a waste heat recovery device of that type, a control device can usefully be provided, which monitors the operating state of the internal combustion engine during normal operation and from that regulates the stroke adjustment device of the axial piston expander in such a way, that the waste heat recovery device supports the internal combustion engine in its drive power. By this means it is possible, that the waste heat recovery device can contribute drive power in the drive train of the internal combustion engine in all speed ranges via its axial piston expander.

According to another embodiment a control device can be provided, which operates the axial piston expander on a cold start of the waste heat recovery device as an axial piston compressor. By this means the axial piston expander is used as an axial piston compressor, with the driven shaft as a drive shaft, a low pressure inlet and a high pressure outlet; the stroke adjuster device operating as an output adjusting device, with which the output power in the case of the axial piston compressor (volume and/or pressure) can be controlled independently of the speed of the drive shaft. On a cold start of the waste heat recovery device all components of the waste heat recovery device are essentially at the ambient temperature, which is clearly below the usual operating temperature of the components of the waste heat recovery device. As a consequence the working medium has an overheated gas component within the waste heat recovery circuit. The delivery device of the waste heat recovery circuit, designed to deliver the fluid working medium against a comparatively high peak pressure, can be subject to cavitation problems at such low pressures and temperatures, which can lead to damage. By using the axial piston expander as an axial piston compressor the working medium can also be easily delivered with a high gas component, so that it is possible in the evaporator to simply allow preheated working medium to circulate in the waste heat recovery circuit, in order to be able to more quickly heat up all components of the waste heat recovery device. This unloads the delivery device. At the same time the time required for the commissioning of the waste heat recovery device is reduced.

According to another advantageous embodiment the driven shaft can be coupled with a part of the drive train, which drives at least one auxiliary unit, such as for example a generator or a pump. This part of the drive train can be decoupled from the remaining drive train by means of a controllable coupling device. A control device can now be formed in such a way, that it can be coupled in an overrun mode of the internal combustion engine and/or in an idle mode of the internal combustion engine actuated to decouple the part of the drive train coupled with the driven shaft from the remainder of the drive train. With the coupling device open the waste heat recovery device can be used via the axial piston expander during overrun operation of the internal combustion engine to drive at least one auxiliary unit. Thus at least the mechanical drive power made available via the axial piston expander can be sensibly made use of. Insofar that a motor vehicle equipped with the internal combustion engine is provided with a recuperation device, during the overrun mode more energy can be converted into a storable energy form, preferably electricity, since the internal combustion engine does not have to apply any driving power to drive the respective auxiliary equipment.

The valve control times can purposely be selected on the inlet side and/or on the outlet side, such that the axial piston expander is not subjected to hydraulic lock. Immediately on a cold start of the waste heat recovery device fluid working medium can appear on the high-pressure side. Since this is comparatively incompressible, precautions must be taken to avoid damage in the event of a compression of the working medium in the expansion machine. On the axial piston expander represented here, in particular an excessive rise in pressure in the respective cylinder can be avoided by the flutter valve.

It is useful if the axial piston expander is lubricated with oil, in which the required amount of lubricating oil can be pumped around a circuit. In particular a working medium with lubricating properties can be used, for example silicone oil.

In accordance with a particularly advantageous embodiment the driven shaft of the axial piston expander can extend from opposite housing ends, such that the driven shaft has two shaft outputs, whereby one shaft output, is coupled with the drive train of the internal combustion engine, in particular via a coupling device, while the other shaft output can be connected to a generator.

The axial piston expander can also be in the form of a swash plate expander or swivel ring expander, or swivel disk expander or wobble plate expander.

So that the axial piston expander can be used during the cold start operation as an axial piston compressor, it may be necessary, to change the opening times and/or closing times of the inlet valves and/or the outlet valves of the individual cylinders, in order to be able to achieve the desired pump function for the cold start operation.

The axial piston expander can be designed for a pressure ratio of 1:50 up to 1:3. The number of cylinders of the axial piston expander is preferably three, four, five, six, seven, eight, nine or eleven. The coupling of the drive shaft of the axial piston expander with the drive train of the internal combustion engine usefully takes place via a toothed belt or via a chain drive or via a gearwheel drive.

Torsional vibration dampers or rubber elements can be provided for the damping of vibration and the decoupling of vibration. Ceramic washers, in particular silicon washers or plastic washers can be provided for the insulation of the hot gas duct in the expander inlet up to the compressor. Furthermore, sheathing can be provided around the complete axial piston expander and sheathing can be provided around a unit of the axial piston expander and the drive-connected generator, in order to thermally insulate these components and units.

Important features and advantages of the invention disclosed in the drawings and the description of the figures on the basis of the drawings are defined in the subclaims.

Exemplary embodiments of the invention will be described below in greater detail with reference to the accompanying drawing.

### BRIEF DESCRIPTION OF THE DRAWINGS

FIG. 1 shows a simplified circuit diagram-type schematic of an internal combustion engine with a waste heat recovery device,

FIG. 2 shows a simplified circuit diagram-type schematic of an axial piston expander with an operating chamber-executed stroke regulation,

FIG. 3 shows a simplified principal detail view of the axial piston expander in the region of a cylinder, and

FIG. 4 shows a simplified principle plan view on a disk care of the axial piston expander.

### DESCRIPTION OF PARTICULAR EMBODIMENTS

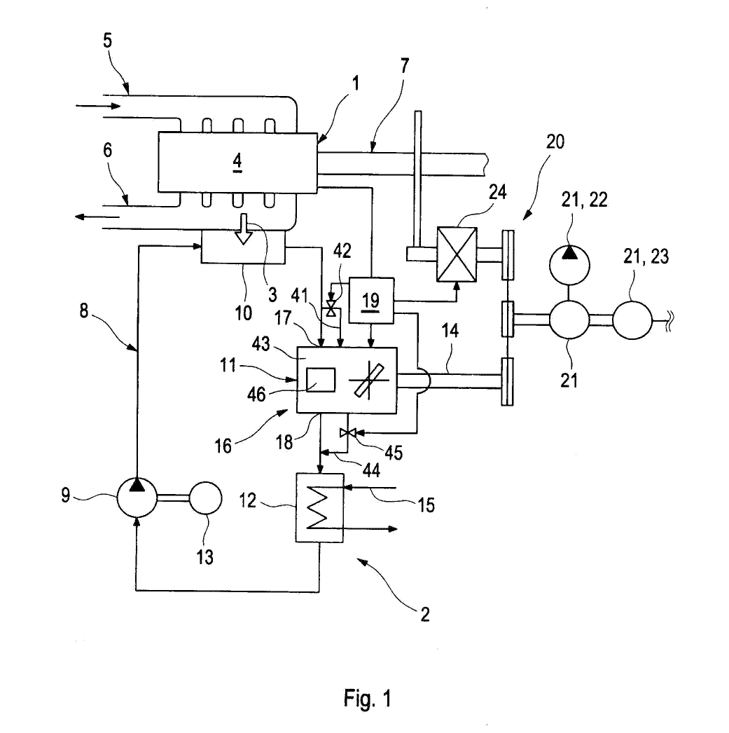

As shown in FIG. 1, an internal combustion engine 1 can in particular be arranged in a motor vehicle equipped with a waste heat recovery device 2, with whose help waste heat can be utilized, which is indicated in FIG. 1 by an arrow 3. The internal combustion engine 1 comprises a motor unit 4, a fresh air system 5 and an exhaust gas system 6. The internal combustion engine 1 drives a drive train 7, which can comprise the customary components such as a crankshaft, a gear box, a flywheel, etc.

The waste heat recovery device 2 comprises a waste heat utilization circuit 8, in which the working medium circulates. In this waste heat utilization circuit 8, one behind the other in the direction of flow of the working medium are located a delivery device 9, an evaporator 10, an expansion machine 11 and a condenser 12. The delivery device 9, which preferably can take the form of a volumetric pump, drives the fluid working medium. These can be equipped with a drive motor 13 for the drive of the delivery device 9.

The evaporator 10 is used for the evaporation of the working medium, whereby the evaporator 10 utilizes the waste heat 3 of the internal combustion engine 1. In the example the evaporator 10 is coupled with the exhaust system 6 for the purpose of the heat transfer. In particular the evaporator 10 is formed as a heat exchanger, which can more or less be integrated in the exhaust gas system 6. Other examples of suitable heat sources are the use of waste heat from a cooling water circuit, from engine and gearbox oil, the heat to be dissipated from a coolant in an air conditioning system or other form of residual heat in the motor vehicle.

The expansion machine 11 is used to relieve the working medium, whereby the expansion machine 11 drives a driven shaft 14. As shown in FIG. 1, this driven shaft 14 is coupled with the drive train 7 and in such a way, that mechanical drive power can be transferred from the driven shaft 14 to the drive train 7.

In the condenser 12 the working medium is condensed. For this purpose the condenser 13 is connected to a cooling circuit 15, which can, in particular, be a cooling circuit for the internal combustion engine 1.

In the waste heat utilization device 2 the expansion machine 11 is in the form of an axial piston expander, which in the following is likewise identified with the reference symbol 11. This axial piston expander 11 is equipped with an inclination adjusting device 16, with which it is possible to adjust the stroke of the axial piston expander 11.

The inclination adjustment device 16 forms, together with an operating chamber pressure regulating device, a stroke adjustment device of the axial piston expander 11.

The operating chamber pressure regulating device has at least one high pressure bypass 41 with a pressure regulating device 42, at least one low pressure bypass 44 with a pressure regulating device 45, an operating chamber 43 of the axial piston expander 11 and a control device 19. For this purpose a bypass 41 branches from the connection between the evaporator 10 and the axial expander 11 before each inlet valve 31 of a cylinder 26, which connects the operating chamber 43 of the axial piston expander 11 via a pressure regulating device 42 with the high pressure of the waste heat recovery circuit 8 at the expander inlet 17. Furthermore, every outlet 18 of a cylinder 26 is connected with a bypass 44, which connects the operating chamber 43 with the low pressure of the expander outlet 18 via a pressure regulating device 45. Via the control device 19 the operating chamber pressure can be regulated by means of the pressure regulating device 42 and/or 45, so that it can assume at least the low pressure at the outlet 18 and at most the high pressure arising at the inlet 17.

The pressure in the operating chamber 43 is effective in the complete operating chamber 43 and hence also on the piston 27. So that the same operating chamber pressure acts on all pistons at the same time, the pressure in the operating chamber 43, acting on the piston 27, is counteracted by the working pressure on the pistons at the sides of the cylinder operating chamber 40. This working pressure is different on each piston 27, depending on the working phase. This leads to a different differential pressure for each piston 27 and these differences change the inclination and the position of the coupling plate 28, and thus the inclination adjustment device 16, and hence the piston stroke of the individual piston 27. By this means it can be provided, that the coupling plate 28 is arranged on the axis 14, so that it can be displaced in defined limits via a mechanism. Furthermore, centrifugal forces influence the position of the coupling plate 28.

Typically the speed of the axial piston expander 11 is determined by the speed of the internal combustion engine 1. Preferably the axial piston expander 11 is forcibly actuated via the connection of its driven shaft 14 with the internal combustion engine 1. By this means changes in the speed of the internal combustion engine lead to changes in the speed of the axial piston expander 11, whereby the expansion ratio and/or the medium flow through the axial piston expander 11 can vary. The resulting change in the waste heat recovery circuit 8 can thereby influence the effectiveness of the waste heat recovery circuit 8. The stroke adjustment provides a counteracting effect.

The waste heat recovery device 2 is equipped with a control device 19, which controls the stroke adjustment device according to the stipulation of the operating status of the internal combustion engine 1. Typically the operating condition is determined, on the basis of establishable operating parameters, whereby these established operating parameters are preferably the speed and the load on the internal combustion engine 1.

To this end the control device 19 determines the operating state of the internal combustion engine 1, assigns this from an expander characteristic diagram to a suitable set stroke and regulates this via the stroke adjustment device. The control device 19 can thus actuate the inclination adjustment device 16 of the stroke adjustment device of the axial piston expander 11 depending on the operating condition of the internal combustion engine 1. Thus the axial piston expander 11 can be controlled in such a way, that in normal operation, at any speed of the internal combustion engine, the expander can transfer the driving power to the drive train 7 of the internal combustion engine 1.

Typically the control device 19 is coupled with the internal combustion engine 1, in particular with an engine control device of the internal combustion engine 1, not shown, and with the axial piston expander 11, the stroke adjustment device and the inclination adjustment device 16 coupled in.

It can also be provided, that the control device 19 determines on the basis of the operating condition of the internal combustion engine 1 the anticipated heat load on the evaporator 3 and/or the speed of the expander.

The part 20 of the drive train 7, with which the driven shaft 14 is coupled, drives in the example at least one auxiliary equipment unit 21, for example a pump 22 or a generator 23 and is coupled via a controllable coupling device 24 with the remaining drive train 7. The control device 19 can actuate the coupling device 24 for the uncoupling of the drive train part 20 from the remaining drive train 7. To this end the control device 19 monitors the current operating condition of the internal combustion engine 1. If the control device 19 establishes an overrun mode or an idling condition of the internal combustion engine 1, it actuates the coupling device 24 for the uncoupling of the Part 20 of the drive train 7, coupled with the driven shaft 14 from the remaining drive train 7. As a consequence the axial piston expander 11 then drives only the respective auxiliary equipment unit 21, while the internal combustion engine 1 can be operated without drive power. In particular thereby the energy, which can be recovered in a recuperator, is increased.

Likewise a direct coupling can be provided between the driven shaft 14 and the part of the drive train 7 directly connected with the internal combustion engine 1 via a controllable coupling device 24

Additionally or alternatively the control device 19 can also be formed in such a way, that in the event of a cold start of the waste heat recovery device 2 the axial piston ex pander 11 operates as an axial piston compressor, in order to convey the working medium from the evaporator 10 towards the condenser 12. By this means the components of the waste heat recovery circuit 8 can be brought to operating temperature more quickly. Further, the danger of damage to the delivery device 9, in particular due to the occurrence of cavitation, is reduced. For the operation of the axial piston expander 11 as an axial piston compressor, the generator 23 can be operated as an electric motor, whereby at the same time the coupling device 24 can be controlled to open.

In a preferred embodiment the operating conditions of the waste heat recovery device 2 are deposited in the control device 19, which corresponds to a cold start operation, a normal operation and an overrun mode. The control device 19 recognizes which operating condition is currently applicable and controls the axial piston expander 11 and the stroke adjustment device according to the requirements for these operating conditions.

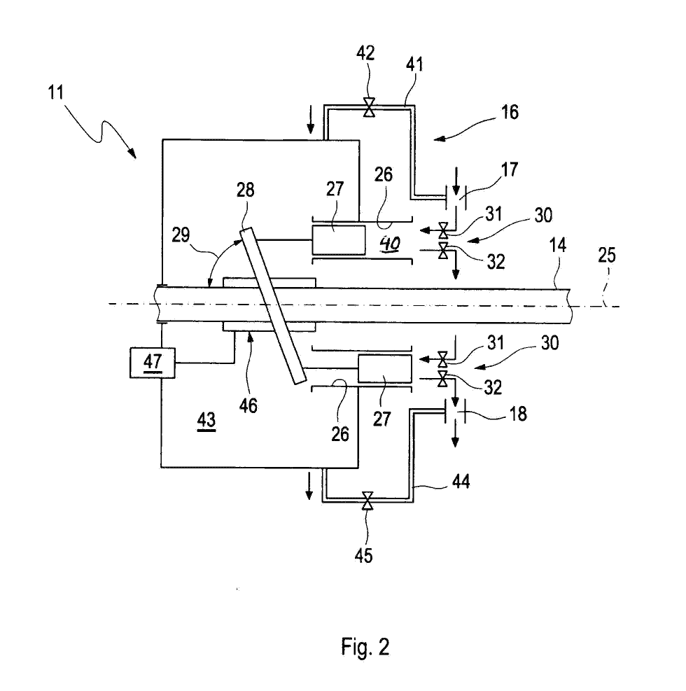

As shown in FIG. 2 the axial piston expander 11 comprises the drive shaft 14, which is mounted to rotate about an axis of rotation 25 and can contribute to the mechanical driving power. Further, the axial piston expander 11 comprises a number of cylinders 26, which are oriented parallel with the axis of rotation 25, i.e. are axially aligned. Also the cylinders 26 are distributed in the circumferential direction with reference to the axis of rotation 25. In the example only two cylinders 26 are represented. It is clear, that the axial piston expander 11 can also have more than two cylinders 26. Further, a piston 27 is provided for each cylinder 26, which is arranged to be adjustable in terms of its stroke in the respective cylinder 26 parallel with the axis of rotation 25. A coupling plate 28 is arranged to be in driven connection with the piston 27 and the driven shaft 14. An inclination 29 of the coupling plate 28 relative to the axis of rotation 25 determines the stroke of the piston 27. In FIG. 2 the upper piston 27 is in its bottom dead center position, at which the related cylinder 26 has its maximum cylinder volume 40, whilst the lower piston 27 lies at its upper dead center position, at which the related cylinder 26 has its minimum cylinder volume. The piston stroke is defined by the path of the piston 27 between the top dead center and the lower dead center positions.

Within the axial piston expander 11 the individual cylinder 26 is respectively con nected on the one hand with the high pressure fluid inlet 17 and on the other hand with the low pressure fluid outlet 18. A valve device 30 is provided for the control of these fluidic connections between the cylinder 26 and the high pressure inlet 17 and the low pressure outlet 18.

Furthermore the axial piston expander 11 is equipped with the previously named stroke adjustment device. The stroke of the piston 27 can be adjusted with the said stroke adjustment device. To this end the stroke adjustment device according to the invention, represented in FIG. 1, has a high pressure bypass 41 branching off from the connection between the evaporator 10 and expander 11, in which in accordance with the represented embodiment a pressure regulating device 42 is arranged. In one embodiment this pressure regulating device 42 takes the form of a constant throttle.

Furthermore, the stroke adjustment device according to the invention, represented in FIG. 1 has a low pressure bypass 44, branching off from the connection between the condenser 12 and the expander 11, in which, in accordance with the embodiment represented in FIG. 1 a pressure regulating device 45 is arranged. In one embodiment this pressure regulating device 42 takes the form of a timing valve.

An embodiment, in which the said stroke adjustment device has an inclination adjustment device, which is given the item reference 16 in the following, is particularly functional. Using this inclination adjustment device 16 the inclination 29 of the coupling plate 28 relative to the axis of rotation 25 can be adjusted. Since the said inclination 29 correlates with the stroke of the piston 27, the adjustment of the inclination of the coupling plate 28 leads to an adjustment of the stroke of the piston 27.

The valve device 30 has an inlet valve 31 for each cylinder 26, 27 and for each cylinder also an outlet valve 32. The respective inlet valve 31 controls the fluidic connection between the respective cylinder 26 and the high pressure inlet 17. In contrast, the respective outlet valve 32 controls the fluidic connection between the respective cylinder 26 and the low pressure outlet 18.

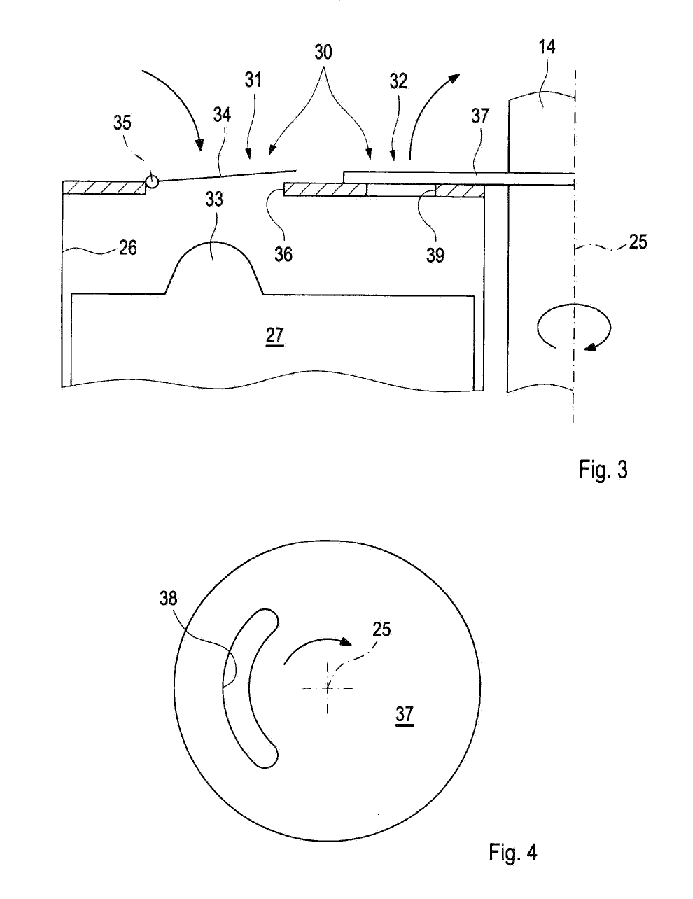

As shown in FIG. 3, the respective inlet valve 31 can be formed in such a way, that it can be actuated by the related piston 27 to open in the region of the top dead center position. For example, the respective piston 27 can be equipped to this end with an actuating element 33, which actuates the associated inlet valve 31 to open in the region of the top dead center position of the piston 27. For example, the actuating element 33 is a protruding element, which protrudes axially outwards, i.e. axially from the piston 27, thus parallel to the axis of rotation 25. In this case the respective inlet valve 31 comprises a valve element 34, which can be adjusted between a closed position, shown in FIG. 3, and an open position. The actuating element 33 contacts the valve element 34 in the region of the top dead center of the piston 27 and moves this into its open position. For example, if the inlet valve 31 is formed as a flutter valve, such that the valve element 34 is a flap, which is likewise identified in the following as item 34 and which can pivot about an axis 35. The pivot axis 35 thereby extends in a plane, which extends at right angles to the axis of rotation 25. The flap 34 is arranged on the side of an inlet opening 36 of the cylinder 26 facing away from the piston 27. By this means the flap 34 is preloaded in its closed position by the inlet side high pressure.

In implementing the respective outlet valve 32 the valve device 30 can have a disk cam 37, which rotates about the axis of rotation 25 and by which the fluidic connection between the respective cylinder 26 and the low pressure outlet 18 can be controlled. To this end the disk cam 37 has, in accordance with FIG. 4, at least one control slot 38, which extends through the disk cam 37 axially, i.e. parallel to the axis of rotation 25. The control slot 38 extends, for example in the form of a circular arc with reference to the axis of rotation 25.

As shown in FIG. 3 the disk cam 37 can expediently be mounted so as to rotate with the drive shaft 14. In addition the disk cam 37 can be so positioned relative to the respective cylinder 26, such that it can directly control an outlet opening 39 of the respective cylinder 26. The respective outlet valve 32 operates such that the fluidic connection between the respective cylinder 26 and the low pressure outlet 18 is then always open, when, due to the relative rotational position of the disk cam 37 with respect to the respective cylinder 26, the control slot 38 is axially aligned with the associated outlet opening 39 of the respective cylinder 26. If, on the other hand, the disk cam 37 is in a rotational position, in which the control slot 38 is not aligned with the associated outlet opening 39 of the respective cylinder 26, the disk cam 37 closes the said outlet opening 39.

The axial piston expander 11 used here can be particularly simply used as an axial piston compressor, if the high pressure inlet 17 is used as a low pressure inlet, if the low pressure outlet 18 is used as a high pressure outlet and if the drive shaft 14 is used as a drive shaft for the driving of the axial piston compressor. The inclination adjusting device 16 can be used on the axial piston compressor then as an output adjusting device, with the help of which the output, in particular volume and/or pressure, can be controlled independently of the speed of the drive shaft (driven shaft 14).

It is also possible to use an axial piston compressor as an axial piston expander 11, in particular in a waste heat recovery device 2. In this case the axial piston compressor comprises a driven shaft 14, which is mounted to rotate about an axis of rotation 25 and into which mechanical driving power can be introduced. Several cylinders 26 to be driven are oriented parallel to the axis of rotation 25 and are arranged distributed over the circumference around the axis of rotation. The several pistons 27 have adjustable strokes by being connected to a coupling plate 28, which is connected to the driven shaft 14 and whose inclination 29 relative to the axis of rotation 25 determines the stroke of the piston 27. A low pressure inlet 17 is in fluidic connection with the cylinders 26 and a high pressure outlet 18 is in fluidic connection with the cylinders 26. There is a valve device 30 for the control of the fluidic connections between the cylinders 26 and the low pressure inlet 17 and also the high pressure outlet 18, with inclination adjustment device 16 for the control of the output. The drive shaft of the axial piston compressor is used as the driven shaft 14 of the axial piston expander 11, to which the mechanical driving power is available, whereas the low pressure inlet of the axial piston compressor is used as the high pressure inlet 17 of the axial piston expander 11, and the high pressure outlet of the axial piston compressor is used as the low pressure outlet 18 of the axial piston expander, and the output adjustment device of the axial piston compressor is used as a stroke adjustment device of the axial piston expander 11, by which the stroke of the piston 27 is independent of the rotational speed and a pressure difference between high pressure and low pressure is controllable.

What is claimed is:

1. An axial piston expander for a waste heat recovery device (2) of a motor vehicle, comprising
a drive shaft (14), which is supported by bearings for rotation about an axis of rotation (25) and from which mechanical driving power can be taken off,
a number of cylinders (26), which are oriented parallel to the axis of rotation (25) and arranged distributed in the circumferential direction around the axis of rotation (25),
a number of pistons (27), arranged in each the cylinders (26) and having an adjustable stroke,
a coupling plate (28) mounted on the drive shaft (14) and connected to all the pistons (27),
a high pressure fluid inlet (17), which is in fluidic connection with the cylinders (26),
a low pressure outlet (18), which is in fluidic connection with the cylinders (26),
a valve device (30) for the control of the fluidic connections between the cylinders (26) and the high pressure inlet (17) as well as the low pressure outlet (18), and
a stroke adjustment device provided, with which the stroke of the piston (27) can be adjusted by a regulation of the pressure in an operating chamber (43) which includes an area at the side opposite the inlet and outlet valves (31, 32).

2. An axial piston expander according to claim 1, wherein the operating chamber (43) can be connected with a high pressure bypass (41) of the high pressure outlet (17) for the adjustment of the operating chamber pressure.

3. An axial piston expander according to claim 2, wherein the operating chamber (43) can be connected to a low pressure bypass (44) of the low pressure outlet (18) for the adjustment of the operating chamber pressure.

4. An axial piston expander according to claim 3, wherein
at least one bypass (41, 44) includes a pressure adjustment device (42, 45).

5. An axial piston expander according to claim 4, wherein
the pressure adjusting device (42, 45) is in the form of one of a timing valve, a constant throttle and another throttle valve.

6. An axial piston expander according to claim 5, wherein
the pressure adjusting device (42, 45) in the first bypass (41, 44) is a timing valve (42, 45) and in the other bypass (44, 41) is a throttle (45, 42).

7. The axial piston expander according to claim 1, wherein the stroke adjustment device comprises an inclination adjustment device (16), whose inclination (29) with respect to the axis of rotation (25) determines the stroke of the pistons (26, 27), the inclination (29) of the coupling plate (28) being be adjusted relative to the axis of rotation (25) being adjustable.

8. The axial piston expander according to claim 1, wherein the valve device (30) comprises an inlet valve (31) for the control of the fluidic connection between the respective cylinder (26) and the high pressure inlet (17), which is arranged so as to be actuated to open by the associated piston (27) in the region of the top dead center.

9. The axial piston expander according to claim 8, wherein the respective piston (27) has an actuating element (33), which actuates the respective inlet valve (31) in the region of the top dead center.

10. The axial piston expander according to claim 9, wherein
the respective actuation element (33) is a protruding element extending xially from the piston (27) for moving a valve element (34) of the inlet valve (31) to an open position.

11. The axial piston expander according to claim 10, wherein
the respective inlet valve (31) is in the form of a flutter valve (31), which as an adjustable valve element has a pivoting flap (34).

12. The axial piston expander according to claim 1, wherein the valve device (30) for the control of the fluidic connection between the cylinders (26) and the low pressure outlet (18) is a disk cam (37) which is rotatable about the axis of rotation (25), and which has at least one control slot (38) axially extending through the disk cam (37), whereby the fluidic connection between the low pressure outlet (18) and the respective cylinder (26) is opened, when the control slot (38) is axially aligned with the respective cylinder (26), and is closed over the remaining range of rotation of the disk cam (37).

13. The axial piston expander according to claim 12, wherein
the control slot (38) extends in the form of a circular arc with respect to the axis of rotation (25),
the disk cam (37) is fixed to the drive shaft (14) for rotation therewith, and
the respective cylinders (26) have outlet openings (39), whose position is directly controlled by the disk cam (37).

14. A waste heat recovery device of a motor vehicle, comprising
a waste heat recovery circuit (8), in which a working medium circulates,
a delivery device (9) arranged in the waste heat recovery circuit (8) for pressurizing the fluid working medium,
an evaporator (10) arranged in the waste heat recovery circuit (8) downstream of the delivery device (9) for the evaporation of the working medium using waste heat (3) of the internal combustion engine (1),
an expansion machine (11) arranged in the waste heat recovery circuit (8) downstream of the evaporator (10) for the decompression of the working medium, and deriving drive power therefrom
a condenser (12) arranged in the waste heat circuit (8) downstream of the expansion machine (11) for the condensing of the working medium,
the expansion machine (11) for the transfer of the mechanical drive power being coupled with, or can be coupled with a drive train (7) of the internal combustion engine (1),
the expansion machine being an axial piston expander (11) according to claim 1, whose driven shaft (14) is coupled with, or can be coupled with the drive train (7) for the transfer of mechanical drive power.

15. The waste heat recovery device according to claim 14, wherein
a control device (19) is provided, which in normal operation monitors the operating state of the internal combustion engine (1) and, based thereon, regulates the stroke adjustment device of the axial piston expander (11) in such a way, that the waste heat recovery device supports the internal combustion engine (1) in its drive power.

16. The waste heat recovery device according to claim 15, wherein the control device (19) is connected to the axial piston expander (11) such that during a cold start of the waste heat utilization device (2), the axial expander is operating as an axial piston compressor.

17. The waste heat recovery device according to claim 16, wherein
the driven shaft (14) is coupled with a part (20) of the drive train (7), which drives at least one auxiliary equipment unit (21),
the part (20) of the drive train (7) can be uncoupled from the remaining drive train (7) by means of a controllable coupling device (24),
a control device (19) is provided, which, in an overrun mode, or in the idle mode of operation of the internal combustion machine (1), actuates the coupling device (24) for the uncoupling of the part (20) of the drive train (7) coupled with the driven shaft (14) from the remaining drive train (7).
